(19) United States
(12) Patent Application Publication
(10) Pub. No.: US 2022/0221223 A1
(43) Pub. Date: Jul. 14, 2022

(54) METHOD OF DRYING A SUBSTANCE USING SECTIONAL TEMPERATURE CONTROL

(71) Applicant: SINGNERGY CORPORATION PTE. LTD., Singapore (SG)

(72) Inventor: Keng Tai CHUA, Singapore (SG)

(73) Assignee: SINGNERGY CORPORATION PTE. LTD., Singapore (SG)

(21) Appl. No.: 17/572,446

(22) Filed: Jan. 10, 2022

(30) Foreign Application Priority Data
Jan. 11, 2021 (SG) 10202100239R

(51) Int. Cl. F26B 17/28; F26B 17/02; F26B 3/347; F26B 25/20

(52) U.S. Cl. CPC F26B 17/286; F26B 25/20; F26B 3/347; F26B 17/026

(57) ABSTRACT

A method of drying a substance, the method comprising the steps of distributing the substance on a first belt having a side adapted to receive the substance; urging the substance via the side of the first belt towards at least two adjacent sections of an exterior circumferential surface of at least one drum rotatable about a central axis; heating the substance on the first belt via a plurality of heating devices arranged proximate to and about each said section of the drum to heat the substance to remove fluids from the substance; and separately controlling the heating devices proximate to each said section of the drum to heat the substance at different heating temperatures at each section thereof while traveling on the first belt around the drum.

### CROSS REFERENCE TO RELATED APPLICATIONS

This application claims priority to, and claims the benefits of, Singapore Patent Application No. 10202100239R filed on Jan. 11, 2021, the content of which is incorporated by reference in its entirety herein.

### FIELD

The present invention relates to a method for drying a substance using sectional temperature control. While the present invention will be described with respect to its application for the drying of substances such as animal/aqua feed, food and food ingredients, it is to be appreciated that the present invention is not restricted to this application, and other applications are also envisaged.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

U.S. Pat. No. 10,571,191 discloses an apparatus for drying a substance developed by the present applicant, hereinafter referred to as the ‘applicant's U.S. patent’. Details of the applicant's U.S. patent are incorporated herein by reference. This apparatus most broadly comprises at least one non-metal drum rotatable about a central axis; and a first metal belt having a first and a second side, the first side of the first belt adapted to receive the substance. One or more heating devices in the form of heat induction elements are arranged proximate to and about a portion of a surface of the drum. During operation of the apparatus, the first belt urges via its first side, the substance towards a portion of an exterior circumferential surface of the drum, while the one or more heat induction elements induce heat in the first belt to heat the substance to remove fluids from the substance, while do not inducing heat in the non-metal drum.

The applicant's U.S. patent further discloses alternative embodiments of the drying apparatus. At least one heat induction element may be arranged within the drum, proximate to and about a portion of an interior surface of the drum. Alternatively, or in addition, at least one heat induction element may be arranged proximate to and about the portion of the exterior surface of the drum. During operation, the substance and the first belt may be driven between a portion of the exterior circumferential surface of the drum and the heat induction element. Other features of these embodiments may include a second belt which may also be made from metal. The second belt may have a first and second side, where in operation, the substance is sandwiched between the second side of the first belt and the first side of the second belt. The second belt may urge via its first side, the substance and the first belt towards the portion of the exterior circumferential surface of the drum. Heat may also be induced in the second belt by the one or more heat induction elements. Furthermore, a plurality of drums may be provided in another embodiment, with the second belt also acting to urge via its first side, the substance and the first belt towards the portion of an exterior circumferential surface of at least one of the drums. The drum may alternatively be made of metal in a single belt configuration of the apparatus.

The drying apparatus disclosed in the applicant's U.S. patent was specifically described for use in the drying of industrial sludge, as well as other substances such as wastewater treatment sludge, food and/or dairy products, food waste and pharmaceutical drugs. The operating temperature of the drying apparatus can be set at a particular value in dependence on the type of substances being dried. However, the applicant found in tests conducted on their drying apparatus revealed that the drying of wet input substances such as food or animal feed ingredients can lead to compromises on the calorific value and optimal nutrition retention of the substances following drying by their apparatus. Furthermore, there was a possibility of increasing undesirable ash content within the substances that have been dried.

An object of the invention is therefore to ameliorate one or more of the above-mentioned difficulties.

### SUMMARY

According to an aspect of the present disclosure, there is provided a method of drying a substance, the method comprising the steps of:

distributing the substance on a first belt having a side adapted to receive the substance;
urging the substance via the side of the first belt towards at least two adjacent sections of an exterior circumferential surface of at least one drum rotatable about a central axis;
heating the substance on the first belt via a plurality of heating devices arranged proximate to and about each said section of the drum to heat the substance to remove fluids from the substance; and
separately controlling the heating devices proximate to each said section of the drum to heat the substance at different heating temperatures at each section thereof while traveling on the first belt around the drum.

In some embodiments, the drum may have a first and second said section, and the method may comprise heating the substance adjacent the first section at a first heating temperature, and heating the substance adjacent the second section at a second heating temperature lower than the first heating temperature.

In some embodiments, the drum may have a first and second said section, and the method may comprise heating the substance adjacent the first section at a first heating temperature, and heating the substance adjacent the second section at a second heating temperature higher than the first heating temperature.

In some embodiments, the drum may have a first said section and at least two subsequent further said sections, and the method may comprise heating the substance adjacent the first section and heating the substance adjacent the at least two subsequent further said sections, the heating temperature progressively decreasing from the first section to the final said section.

In some embodiments, the drum may have a first said section and at least two subsequent further said sections, and the method may comprise heating the substance adjacent the first section and adjacent the at least two subsequent further said sections, the heating temperature progressively increasing from the first section to the final said section.

In some embodiments, the drum may have a first said section and at least two subsequent further said sections, and the method may comprise heating the substance adjacent the first section and adjacent the at least two subsequent further said sections, the heating temperature varying between higher and lower values from the first section to the final said section.

In some embodiments, the method may further comprise heating the substance at differing durations at each section of the drum.

In some embodiments, the drum may have a first said section and at least one further subsequent said section, and the method may comprise heating the substance adjacent the first section for a shorter duration than in the at least one subsequent section.

In some embodiments, the drum may have a first said section and at least one further subsequent said section, the method comprising heating the substance adjacent the first section for a longer duration than in the at least one subsequent section.

In some embodiments, the method may comprise heating the substance at the same duration at each said section of the drum.

In some embodiments, the heating devices may be located in close proximity to an external circumferential surface of the drum. Alternatively, the heating devices may be located in close proximity to an internal circumferential surface of the drum.

In some embodiments, the heating devices may be heat induction elements, the first belt may be made of metal, and the drum may be made from non-metal, and the method may comprise inducing heat in the first belt to heat the substances to remove fluids from the substance, and not induce heat in the drum.

In some embodiments, comprising a second belt having a side, the method may comprise sandwiching the substance between the side of the first belt and the side of the second belt, the first belt urging via its side the substance and the second belt towards the portion of the exterior circumferential surface of the drum. The second belt may be made of metal, and the drum may be made from non-metal, and the method may further comprise inducing heat in the second belt to heat the substances to remove fluids from the substance, and not induce heat in the drum.

In some embodiments, comprising temperature sensors for measuring the heating temperature at each said section, the method may comprise adjusting the heating temperature towards a predetermined set temperature at each said section as required in response to measurements taken by the temperature sensors.

According to another aspect of the present disclosure, there is provided a method of drying a substance, the method comprising the steps of:

distributing the substance on a first belt having a side adapted to receive the substance;
respectively urging the substance via the side of the first belt towards a section of an exterior circumferential surface of a plurality of drums, each drum being rotatable about a respective central axis;
heating the substance on the first belt via a plurality of heating devices respectively arranged proximate to and about the section of each of the plurality of drums to heat the substance to remove fluids from the substance;
and
separately controlling the heating devices proximate to the section of each of the drums so that the substance is heated at different temperatures while traveling on the first belt around each of the drums.

In some embodiments, the drum may have a first and second said drum, and the method may comprise heating the substance adjacent the section of the first drum at a first heating temperature, and heating the substance adjacent the section of the second drum at a second heating temperature lower than the first heating temperature.

In some embodiments, comprising a first and second said drum, the method may comprise heating the substance adjacent the section of the first drum at a first heating temperature, and heating the substance adjacent the section of the second drum at a second heating temperature higher than the first heating temperature.

In some embodiments, comprising a first said drum and at least two subsequent further said drums, the method may comprise heating the substance adjacent the section of the first drum and adjacent the section of the at least two subsequent further drums, the heating temperature progressively decreasing from the first drum to the final said drum.

In some embodiments, comprising a first said drum and at least two subsequent further said drums, the method may comprise heating the substance adjacent the section of the first drum and adjacent the section of the at least two subsequent further drums, the heating temperature progressively increasing from the first drum to the final said drum.

In some embodiments, comprising a first said drum and at least two subsequent further said drums, the method may comprise heating the substance adjacent the section of the first drum and adjacent the section of the at least two subsequent further drums, the heating temperature varying between higher and lower values from the first drum to the final said drum.

In some embodiments, the method may further comprise heating the substance at differing durations at each drum.

In some embodiments, comprising a first said drum and at least one further subsequent said drum, the method may comprise heating the substance adjacent the section of the first said drum for a shorter duration than in the section of the at least one subsequent said drum.

In some embodiments, comprising a first said drum and at least one further subsequent said drum, the method may comprise heating the substance adjacent the first said drum for a longer duration than in the at least one subsequent said drum.

In some embodiments, the method may comprise heating the substance at the same duration at each said drum.

In some embodiments, the heating devices may be located in close proximity to an external circumferential surface of each said drum. Alternatively, the heating devices may be located in close proximity to an internal circumferential surface of each said drum.

In some embodiments, the heating devices may be heat induction elements, the first belt may be made of metal, and the drums may be made from non-metal, and the method may comprise inducing heat in the first belt to heat the substances to remove fluids from the substance, and not induce heat in the drums.

In some embodiments comprising a second belt having a side, the method may comprise sandwiching the substance between the side of the first belt and the side of the second belt, the first belt urging via its side the substance and the second belt towards the portion of the exterior circumferential surface of each of the drums. The second belt may be made of metal, and the drum may be made from non-metal, and the method may further comprise inducing heat in the second belt to heat the substances to remove fluids from the substance, and not induce heat in the drums.

In some embodiments, comprising temperature sensors for measuring the heating temperature at the section of each said drum, the method may comprise adjusting the heating temperature towards a predetermined set temperature at each said drum as required in response to measurements taken by the temperature sensors.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIGS. 1a to 1c are schematic side views of a drying apparatus having a single drum with at least one heating device located proximal to an external circumferential surface of the drum, and respectively showing single, two and multiple sectional temperature control of the drying apparatus according to the present disclosure;

FIGS. 2a to 2c are schematic side views of a drying apparatus having a single drum with at least one heating device located proximal to an internal circumferential surface of the drum, and respectively showing single, two and multiple sectional temperature control of the drying apparatus according to the present disclosure;

FIG. 3: are schematic side views respectively showing single, double and multiple drum configurations of a drying apparatus according to the present disclosure; and

FIG. 4 is a schematic side view showing the control of a two sectional temperature controlled drying apparatus according to the present disclosure.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

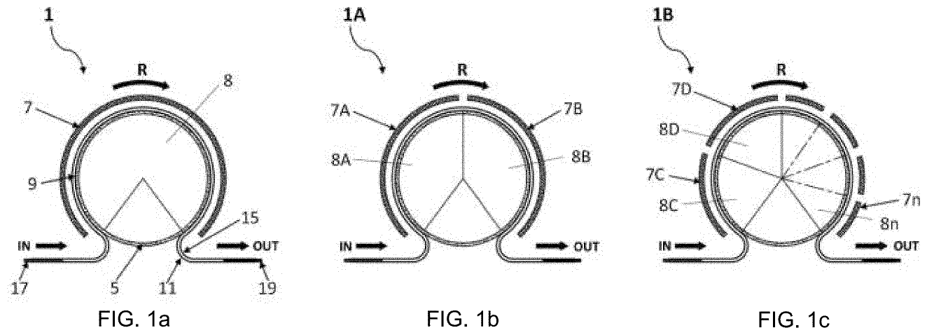

Referring initially to FIG. 1a, there is shown a drying apparatus 1 having a single drum configuration as generally disclosed in the applicant's U.S. patent. That comprises a drum 5 that rotates about a central axis in a rotational direction as shown by arrow R, and one or more heating devices 7 externally arranged around and proximate to and about a major portion of an external circumferential surface 9 of the drum 5. The heating devices 7 may be in the form of heat induction elements, and the drum 5 may be made from non-metal so that the heat induction elements do not induce heat in the drum 5. It is alternatively envisaged the other forms of heating devices such as, but not limited to, electric coil heaters or infra-red heaters could be used. FIG. 1a shows the heating devices 7 extending around and in close proximity to a major portion of the drum external circumferential surface 9. These heating devices 7 are schematically shown as arcuate bands in FIGS. 1a and 1n subsequent Figs. where the heating devices 7 are shown. It is however to be appreciated that the arcuate bands shown in FIG. 1a and in subsequent Figs. can represent either a single arcuate heating device 7 or a row of heating devices 7 provided around the portion of the circumference of the drum 5. The following description should therefore be understood with this in mind.

The drying apparatus 1 further comprises a first inner belt 11 and a second outer belt 15 respectively. The outer belt 15 overlaps the inner belt 11, with the wet substance 17 to be dried being initially sandwiched between the two belts downstream of the drum 5 designated by arrow ‘IN’ in FIG. 1a and subsequent figures. The inner and outer belts 11,15 then carry the wet substance 17 therebetween over an exterior circumferential surface of the rotating drum 5 and under the heating devices 7 as shown in FIGS. 1a to 1 c. The inner and outer belts 11,15 may be made from metal so that heat can be induced within the inner and outer belts 11, 15 as they travel in close proximity to the heating devices 7 when they are in the form of heat induction elements. The induced heat thereby progressively evaporates the fluid contained within the wet substance 17. The final dried product 19 is then produced downstream of the drum 5 designated by the arrow ‘OUT’. While two belts are shown in the Figs. of the drying apparatus according to the present disclosure, it is to be appreciated that the drying apparatus can also operate using only use a single belt for urging the wet substance towards a portion of an exterior circumferential surface of the drum as is described in the applicant's U.S. patent.

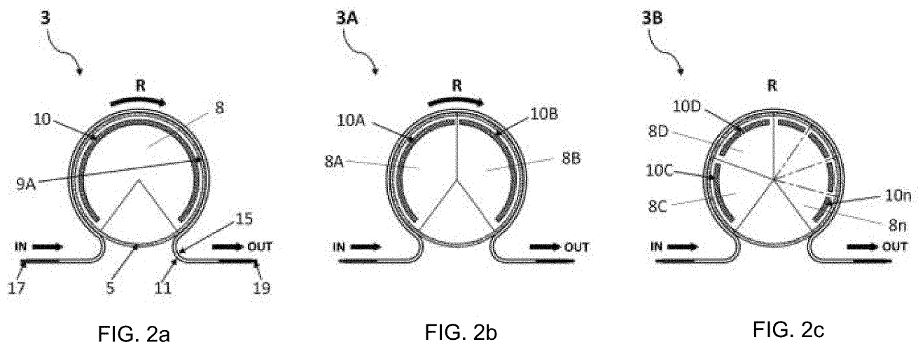

FIG. 2a also shows another configuration of a drying apparatus 3 based on the disclosure in the applicant's U.S. patent, and the same reference numerals are used for corresponding features as shown in FIG. 1a. The primary difference from the configuration shown in FIG. 1a is that the heating devices 10 are located internally within the drum 5 in close proximity to an interior circumferential surface 9a of the drum 5 as shown in FIG. 2a. The drying apparatus 3 can however otherwise operated in the same way as the drying apparatus shown in FIG. 1a.

In the drying apparatus 1,3 respectively shown in FIGS. 1a and 2a, the heating devices 7,10 are controlled to provide heat to the substances 17 held between the inner and outer belts 11,15 while supported on the portion of the exterior circumferential surface of the drum 5 that is at that point of time positioned in proximity to the heating devices 7,10. As the drum 5 continuously rotates about its central axis during operation of the drying apparatus 1,3, the portion of the drum exterior surface 9 supporting the inner and outer belts 11,15 will therefore vary with time. Nevertheless, at any point of time, a section 8 of the drum 5 will be located proximate to the heating devices 7, with this section 8 being shown schematically in FIGS. 1a and 2a.

The heating devices 7 in the drying apparatus respectively shown in FIGS. 1a and 2a are controlled to provide heating to a single section 8 of the drum 5 about which the heating devices 7 are located at the time. Therefore, a similar heating temperature is provided by the heating devices 7 to that single section 8 of the drum 5. This will be referred to as providing ‘single or one sectional temperature control’ of the heating devices 7 for the drying apparatus 1,3. The apparatus for drying a substance according to the present disclosure however provides for separate temperature control in different sections of the drum 5. In the drying apparatus 1A,3A shown in FIGS. 1b and 2b, there is respectively shown two separate heating devices 7A,7B,10A,10B respectively located over different sections 8A,8B of the rotating drum 5. This arrangement therefore provides for what will be referred to as ‘two sectional temperature control’ for the drying apparatus 1A, 3A. In the drying apparatus 1B,3B respectively shown in FIGS. 1c and 2c, a plurality of heating devices 7C to 7n,10C to 10n are shown respectively located over more than two different sections 8B to 8n of the rotating drum 5. This arrangement therefore provides for what will be referred to as ‘multiple sectional temperature control’ of the heating devices 7C to 7n,10C to 10n for the drying apparatus 1B, 3B.

FIGS. 1 and 2 show the different sections of the drum 5 to be uniform in size. It is however also envisaged that the sections vary in size across the drum. For example, the first section may extend over a narrower portion of the drum than a subsequent section. This may allow the substance to for example be initially subjected to a high heating temperature in the first region, and being subjected to a longer period where the heating temperature is lower in a subsequent region extending over a wider portion of the drum. The duration of time at which a substance may be heated within any particular section can therefore be the same when the sections are of the same size. Alternatively, the duration at each section may vary from section to section depending on the relative size of each section.

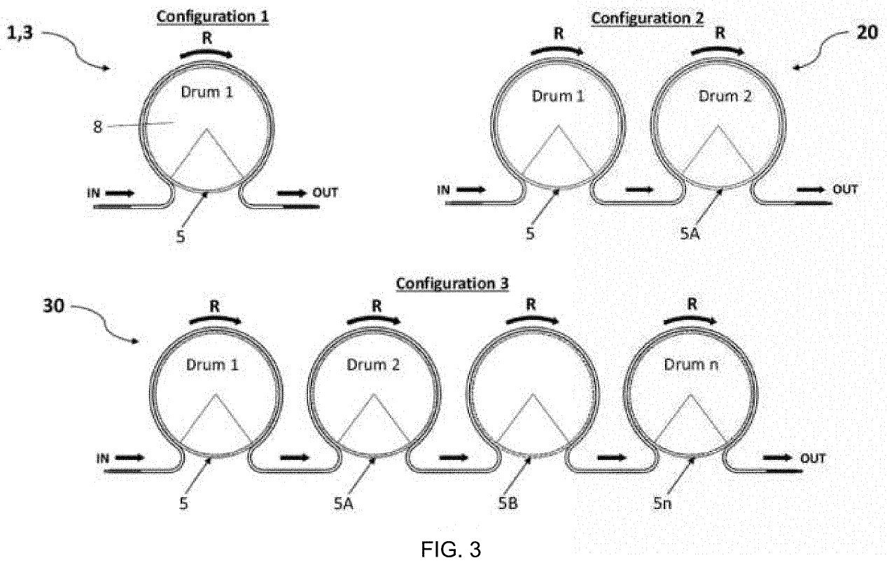

It is also envisaged that sectional temperature control be provided by a using a plurality of drums 5. FIG. 3 shows three different configurations of the drying apparatus that illustrate how this sectional temperature control be achieved using multiple drums. Configuration 1 shows the drying apparatus 1,3 respectively shown in FIGS. 1a and 1b having a single drum 5 with one section 8 being heated. This configuration provides for single sectional temperature control of the heating devices (not shown). Two and multiple sectional temperature control may however also be achieved by a drying apparatus using a plurality of drums according to the present disclosure. Configuration 2 provides for a drying apparatus 20 having two separate drums 5,5A, with each drum also having single section to be heated. However, the heating temperature provided for the first drum 5 can be different from the heating temperature provided for the second drum 5A. The inner and outer belts 11,15 will then sequentially travel over each drum 5,5A, and can then be heated to different temperatures while sequentially passing over each drum 5,5A. This arrangement therefore provides a similar function to the two sectional temperature control drying apparatus respectively shown in FIGS. 1b and 2b. Configuration 3 shows a drying apparatus 30 having more than two drums 5, 5A to 5n. The heating temperature provided for the first drum 5 can be different from the heating temperatures provided for each of the subsequent drums 5A to 5n. The inner and outer belts 11,15 will then sequentially travel over each drum 5 to 5n, and can then be heated to a different temperature at each drum 5 to 5n. This arrangement therefore provides a similar function to the multiple sectional temperature control drying apparatus respectively shown in FIGS. 1c and 2c. It is also envisaged that at least one of the drums in configuration 2 or 3 be provided with 2 or multiple sectional temperature control.

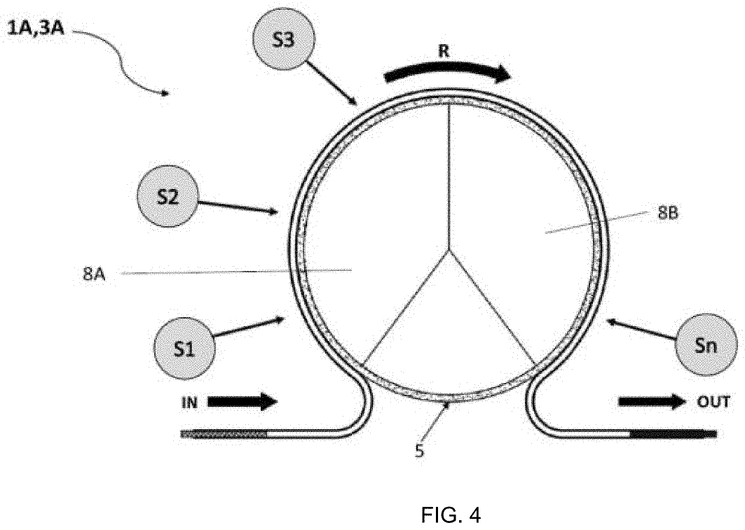

FIG. 4 illustrates how sectional temperature control can be implemented according to the present disclosure. This is shown for example on a drying apparatus provided with two sectional temperature control similar to the drying apparatus 1A,3A respectively shown in FIGS. 1b and 2b. Temperature control is provided for the heating devices (not shown) located at the time over the two sections 8A,8B of the drum 5. One or more temperature sensors S1 to Sn are located proximate each section 8A,8B to measure the temperature at different locations around the drum 5. The heating devices within each section 8A,8B can then be respectively controlled to ensure that the required heating temperature is maintained for each section. Variations in temperature within each section can then be taken into account by adjusting the appropriate heating devices to ensure that the temperature is adjusted to meet the required heating temperature for that section.

The variation in the heating temperature that the substance supported by the inner and outer belts 11,15 may be dependent on the type of substance being dried. For example, the temperature may be controlled in a two sectional temperature control system such that the substances may be initially subjected to a high heating temperature at the first section or first drum, and may be subsequently subjected to lower heating temperatures at the second section or second drum. The heating temperatures can also be controlled to progressively decrease over several sections or drums in the case of multiple sectional temperature control. It is also envisaged that the progression of heating temperature changes be reversed with the substance being initially subjected to a lower heating temperature at the first section or first drum, and may be subjected to higher temperature at the second or latter sections or drums. The use of heating temperature sequences where the temperature values alternate or otherwise vary between higher and lower values across multiple drum sections is also envisaged.

Fine temperature sectional control within a single heating system is especially crucial in animal/aqua feed, food and food ingredient production to enable superior retention of nutrition and/or retention of calorific value in biomass to produce high value dried products at desired dryness.

Heating temperature and duration are two critical factors in calorific and/or nutritional value retention and dryness of products such as food and food ingredients, animal and aqua feed. The ideal case scenario will be to dry wet input substance at the shortest time possible to achieve the desired moisture content. The drying apparatus according to the present disclosure can do so by subjecting the wet input substance briefly at high temperatures to evaporate or dehydrate majority of the water upon first hot surface contact followed by lowering the temperatures progressively at the subsequent sections so as to retain the heat value, nutritional content, protein, flavour and other organoleptic properties as much as possible.

Lowering the temperature at subsequent sections is also directly proportional to energy consumption. Lower the temperature setting, lesser the energy used. Therefore, the overall energy consumption will be reduced.

The sectional temperature control used in the drying apparatus according to the present disclosure will therefore further enhance dried output product consistency and quality while simultaneously reducing overall energy consumption.

Experimental results conducted on an experimental prototype of the drying apparatus according to the present disclosure have indicate that different temperatures set in each section reflect different energy consumptions respectively with better dried output quality.

The drying apparatus according to the present disclosure provides additional advantages for animal/aqua feed production, fertilizer, food and/or food ingredients and biomass production processes. Therefore, the drying apparatus having sectional temperature control will be applicable for industries which have processes requiring fine temperature control to retain nutritional value, organoleptic properties and calorific values as follows:

Aquaculture

Fish processing facilities can look to convert fish waste into wholesome, aromatic and nutritious components of feed for various animals to boost nourishment and taste.

The aquaculture industry in fish/shrimp feed production has been gradually moving away from wild feed for some time and have identified the need to manufacture fish feed with high nutrition while raising productivity, strengthen climate resilience and overcome resource constraints.

Agriculture

Agricultural wastes such as vineyard fruit waste, pineapple waste can be turned into fertilizers or animal feed of higher value. Palm oil and paper mill sludge can be turned into biomass.

Food Processing

Food processing operations such as meat, poultry or seafood processing plants produce large amounts of organic side streams that are rich in nutrients. The invention will convert these side streams into products containing high levels of protein and minerals for animal or aquatic feed.

Plant based food processing waste such as spent coffee, okara or spent barley contains specific nutrition within the waste material. Specific temperature control will be able to retain a large proportion of the desirable nutrients in dried form and be used as fertilizers, animal/aqua feed or food ingredients.

Plant side streams for new product innovation using homogeneous fruit waste such as durian or pineapple skins are found to contain high fibrous content. Industries looking to use renewable resources on products to improve strength, water proofing and texture-based applications will benefit from the sectional temperature control to ensure fibers retain high strength (overheating will make the fibers brittle and weak) and retain gel-like bonding substances to ensure durable, good quality end products.

Mixed waste from the kitchen were found to contain calorific values more than 5000 kcal/kg. Such values are comparable to coal. The kitchen wastes are able to achieve such levels of calorific value due to the short time and fine temperature controls of the input substance to produce high quality biomass.

Dried food production plants looking to dry wet food into dry food products for human consumption will produce dried food products high in organoleptic and nutritional content due to the fine temperature controls. Examples include traditional Chinese medication production plants or flour mills.

Livestock Farming

Cow manure is a good fertilizer, being a source of micronutrients containing 3% nitrogen, 2% phosphorus, and 1% potassium (3-2-1 NPK). The dying apparatus according to the present disclosure can produce fertilizers high in micro nutrients essential for agricultural applications.

Sludge Drying

The drying apparatus according to the present disclosure can improve energy efficiency in almost all kinds of organic and inorganic sludge such as sewage sludge, palm oil sludge, paper sludge, food sludge, biogas residual, digested manure, petrochemical, hydroxide sludge and sludge found at waste water treatment facilities etc. When organic sludge is dried more precisely, it will give rise to higher calorific/heat values which ends up as superior biomass.

Dried sludge is suitable for a variety of applications such as sludge reduction prior to incineration, combustion and gasification or producing refuse-derived fuel (RDF), hence the quality of biomass will be an important advantage.

Unless defined otherwise, all technical and scientific terms used herein have the same meaning as is commonly understood by a skilled person to which the subject matter herein belongs.

It should be appreciated by the person skilled in the art that the above invention is not limited to the embodiment described. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A method of drying a substance, the method comprising the steps of:
distributing the substance on a first belt having a side adapted to receive the substance;
urging the substance via the side of the first belt towards at least two adjacent sections of an exterior circumferential surface of at least one drum rotatable about a central axis;
heating the substance on the first belt via a plurality of heating devices arranged proximate to and about each said section of the drum to heat the substance to remove fluids from the substance; and
separately controlling the heating devices proximate to each said section of the drum to heat the substance at different heating temperatures at each section thereof while traveling on the first belt around the drum.

2. The method of drying a substance according to claim 1, the drum having a first and second said section, the method comprising heating the substance adjacent the first section at a first heating temperature, and heating the substance adjacent the second section at a second heating temperature lower than the first heating temperature.

3. The method of drying a substance according to claim 1, the drum having a first and second said section, the method comprising heating the substance adjacent the first section at a first heating temperature, and heating the substance adjacent the second section at a second heating temperature higher than the first heating temperature.

4. The method of drying a substance according to claim 1, the drum having a first said section and at least two subsequent further said sections, the method comprising heating the substance adjacent the first section and adjacent the at least two subsequent further said sections, the heating temperature progressively decreasing from the first section to the final said section.

5. The method of drying a substance according to claim 1, the drum having a first said section and at least two subsequent further said sections, the method comprising heating the substance adjacent the first section and adjacent the at least two subsequent further said sections, the heating temperature progressively increasing from the first section to the final said section.

6. The method of drying a substance according to claim 1, the drum having a first said section and at least two subsequent further said sections, the method comprising heating the substance adjacent the first section and adjacent the at least two subsequent further said sections, the heating temperature varying between higher and lower values from the first section to the final said section.

7. The method of drying a substance according to claim 1, further comprising heating the substance at differing durations at each section of the drum.

8. The method of drying a substance according to claim 7, the drum having a first said section and at least one further subsequent said section, the method comprising heating the substance adjacent the first section for a shorter duration than in the at least one subsequent section.

9. The method of drying a substance according to claim 7, the drum having a first said section and at least one further subsequent said section, the method comprising heating the substance adjacent the first section for a longer duration than in the at least one subsequent section.

10. The method of drying a substance according to claim 1, further comprising heating the substance at the same duration at each said section of the drum.

11. The method of drying a substance according to claim 1, wherein the heating devices are located in close proximity to an external circumferential surface of the drum.

12. The method of drying a substance according to claim 1, wherein the heating devices are located in close proximity to an internal circumferential surface of the drum.

13. The method of drying a substance according to claim 1, wherein the heating devices are heat induction elements, the first belt is made of metal, and the drum is made from non-metal, the method comprising inducing heat in the first belt to heat the substances to remove fluids from the substance, and not induce heat in the drum.

14. The method of drying a substance according to claim 13, comprising a second belt having a side, the method further comprising sandwiching the substance between the side of the first belt and the side of the second belt, the first belt urging via its side the substance and the second belt towards the portion of the exterior circumferential surface of the drum.

15. The method of drying a substance according to claim 14, wherein the second belt is made of metal, and the drum is made from non-metal, the method further comprising inducing heat in the second belt to heat the substances to remove fluids from the substance, and not induce heat in the drum.

16. The method of drying a substance according to claim 1, comprising temperature sensors for measuring the heating temperature at each said section, the method comprising adjusting the heating temperature towards a predetermined set temperature at each said section as required in response to measurements taken by the temperature sensors.

17. A method of drying a substance, the method comprising the steps of:
distributing the substance on a first belt having a side adapted to receive the substance;
respectively urging the substance via the side of the first belt towards a section of an exterior circumferential surface of a plurality of drums, each drum being rotatable about a respective central axis;
heating the substance on the first belt via a plurality of heating devices respectively arranged proximate to and about the section of each of the plurality of drums to heat the substance to remove fluids from the substance;
and
separately controlling the heating devices proximate to the section of each of the drums so that the substance is heated at different temperatures while traveling on the first belt around each of the drums.

18. The method of drying a substance according to claim 17, comprising a first and second said drum, the method comprising heating the substance adjacent the section of the first drum at a first heating temperature, and heating the substance adjacent the section of the second drum at a second heating temperature lower than the first heating temperature.

19. The method of drying a substance according to claim 17, comprising a first and second said drum, the method comprising heating the substance adjacent the section of the first drum at a first heating temperature, and heating the substance adjacent the section of the second drum at a second heating temperature higher than the first heating temperature.

20. The method of drying a substance according to claim 17, comprising a first said drum and at least two subsequent further said drums, the method comprising heating the substance adjacent the section of the first drum and adjacent the section of the at least two subsequent further drums, the heating temperature progressively decreasing from the first drum to the final said drum.

21. The method of drying a substance according to claim 17, comprising a first said drum and at least two subsequent further said drums, the method comprising heating the substance adjacent the section of the first drum and adjacent the section of the at least two subsequent further drums, the heating temperature progressively increasing from the first drum to the final said drum.

22. The method of drying a substance according to claim 17, comprising a first said drum and at least two subsequent further said drums, the method comprising heating the substance adjacent the section of the first drum and adjacent the section of the at least two subsequent further drums, the heating temperature varying between higher and lower values from the first drum to the final said drum.

23. The method of drying a substance according to claim 17, comprising heating the substance at differing durations at each drum.

24. The method of drying a substance according to claim 23, comprising a first said drum and at least one further subsequent said drum, the method comprising heating the substance adjacent the section of the first drum for a shorter duration than in the section of the at least one subsequent drum.

25. The method of drying a substance according to claim 23, comprising a first said drum and at least one further subsequent said drum, the method comprising heating the substance adjacent the first said drum for a longer duration than in the at least one subsequent said drum.

26. The method of drying a substance according to claim 17, comprising heating the substance at the same duration at each said drum.

27. The method of drying a substance according to claim 17, wherein the heating devices are located in close proximity to an external circumferential surface of each said drum.

28. The method of drying a substance according to claim 17, wherein the heating devices are located in close proximity to an internal circumferential surface of each said drum.

29. The method of drying a substance according to claim 17, wherein the heating devices are heat induction elements, the first belt is made of metal, and the drums are made from non-metal, the method comprising inducing heat in the first belt to heat the substances to remove fluids from the substance, and not induce heat in the drums.

30. The method of drying a substance according to claim 29, comprising a second belt having a side, the method further comprising sandwiching the substance between the side of the first belt and the side of the second belt, the first belt urging via its side the substance and the second belt towards the portion of the exterior circumferential surface of each of the drums.

31. The method of drying a substance according to claim 30, wherein the second belt is made of metal, and the drum is made from non-metal, the method further comprising inducing heat in the second belt to heat the substances to remove fluids from the substance, and not induce heat in the drums.

32. The method of drying a substance according to claim 17, comprising temperature sensors for measuring the heating temperature at the section of each said drum, the method comprising adjusting the heating temperature towards a predetermined set temperature at each said drum as required in response to measurements taken by the temperature sensors.
